(19) United States
(12) Patent Application Publication
(10) Pub. No.: US 2004/0258113 A1
(43) Pub. Date: Dec. 23, 2004

(54) Method of determining the decay of a laser diode

(75) Inventor: Chi Yuan Liu, Taipei City (TW)

Correspondence Address: BACON & THOMAS, PLLC, 625 SLATERS LANE, FOURTH FLOOR, ALEXANDRIA, VA, 22314

(73) Assignee: LITE-ON IT CORPORATION, Taipei City (TW)

(21) Appl. No.: 10/853,363

(22) Filed: May 26, 2004

(30) Foreign Application Priority Data
Jun. 18, 2003 (TW) 092116581

(51) Int. Cl. H01S 3/00

(52) U.S. Cl. 372/38.01; 372/38.02

(57) ABSTRACT

The present invention discloses a method of determining the decay of a laser diode. Firstly, a specific digital control signal is input to obtain a measured driving signal and a measured feedback signal. Then, the decay of a laser diode is determined according to a specific driving signal and a specific feedback signal, which are obtained by a specific digital controlling signal and stored in a read-only memory when the manufacturing of an optical drive is completed.

This application claims the benefit of Taiwan application Serial No. 92116581, filed Jun. 18, 2003, the subject matter of which is incorporated herein by reference.

### BACKGROUND OF THE INVENTION

1. Field of the Invention

The invention relates in general to a laser diode disposed within an optical disk drive, and more particularly to a method of determining the decay of a laser diode disposed within an optical disk drive.

2. Description of the Related Art

Normally, a laser diode is disposed in an optical pick-up head of an optical disk drive and serves as a light source of the optical pick-up head. In an optical disk drive, a controlling chip precisely outputs a driving current to control the laser diode to output laser beams of varied power levels so that the laser diode can stably read data from or write data onto an optical disk under varied environments or status.

However, the laser diode, whose lifespan is limited, cannot stably output power and needs to be replaced when the laser diode reaches a severe level of decay. According to a conventional method of determining the decay of the laser diode disposed within an optical disk drive, the optical disk drive manufacturer has to disassemble the optical disk drive in order to detect the decay of the laser diode by an optical detector. Such a detecting process is not only labor consuming but also inefficient. Thus there arises the need for a decay determining method, which uses these available circuits within the optical disk drive to quickly determine the decay of the laser diode within the optical disk drive.

### SUMMARY OF THE INVENTION

It is therefore an object of the invention to provide a method of determining the decay of a laser diode. The method determines the decay of a laser diode according to a driving signal and a feedback signal of a closed-loop laser power controlling circuit of the laser diode disposed within an optical disk drive.

The method of determining the decay of a laser diode according to the invention is briefly disclosed as follows:

Provide a specific digital controlling signal to a closed-loop controlling circuit to enable the laser diode to generate a laser beam. Measure a measured feedback signal that a front monitor diode of the closed-loop controlling circuit outputs after receiving the laser beam. Measure a measured driving signal outputted by a compensator of the closed-loop controlling circuit. Determine the decay of the laser diode according to the specific feedback signal and the specific driving signal as well as the measured feedback signal and the measured driving signal. The digital controlling signal, the specific feedback signal and the specific driving signal are stored in a ROM in advance.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a closed-loop power controlling circuit of a laser diode disposed within an optical disk drive; and

FIG. 2 is a flowchart of determining the decay of a laser diode according to the invention.

### DETAILED DESCRIPTION OF THE INVENTION

Normally, the laser power of the laser diode disposed within an optical disk drive is controlled by a firmware by changing a digital controlling signal, which may be converted into an analog controlling signal via a digital-to-analog converter (DAC). Next, a compensator and an amplifier are used to generate a driving current, which drives the laser diode to output laser power at a predetermined level. To maintain the laser power outputted by the laser diode at a fixed level, a front monitor diode (FMD) is used to receive the laser beam outputted by the laser diode and to generate a feedback signal, by which the laser power can be adjusted to complete a closed-loop controlling circuit.

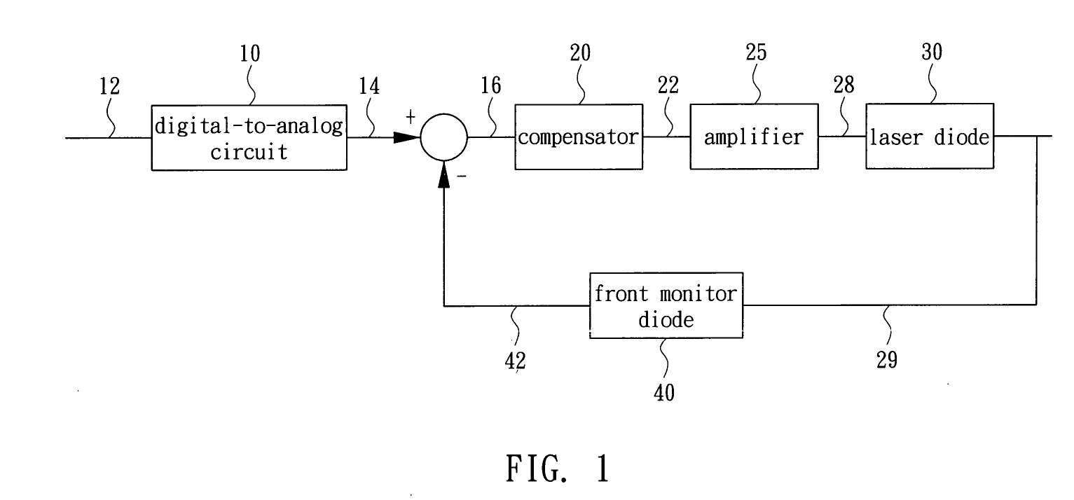

Referring to FIG. 1, a block diagram of a closed-loop power controlling circuit of a laser diode disposed within an optical disk drive is shown. Firstly, a digital-to-analog converter (DAC) 10 receives a digital controlling signal 12 and converts the digital controlling signal 12 into an analog controlling signal 14. An error signal 16, which is generated from the difference value of the analog controlling signal 14 and an analog feedback signal 42, is inputted into a compensator 20. The compensator 20 generates and outputs a driving signal 22 to an amplifier 25 according to the error signal 16. The amplifier 25 amplifies and outputs the driving signal 22 to be a driving current 28 to a laser diode (LD) 30. After receiving a laser beam 32 outputted by the laser diode 30 according to the driving current 28, a front monitor diode (FMD) 40 outputs a feedback signal 42.

Since the laser power of the laser diode disposed within an optical disk drive is controlled by a closed-loop circuit, the compensator may change the driving signal according to the magnitude of the error signal such that the laser diode may stably output laser power according to the level determined by the digital controlling signal. In other words, the compensator may compensate the decay of the laser diode before a certain level of decay is reached. Meanwhile, the front monitor diode will not generate different feedback signals due to the decay of the laser diode.

The compensator can only compensate the decay to a certain level. Provided that the laser diode has reached a certain degree of decay and that the compensator has reached a saturation point, the driving current outputted from the amplifier cannot enable the laser diode to output laser power at a level determined by the digital controlling signal. Meanwhile, the feedback signal outputted by the front monitor diode will be weakened.

According to the above characteristics, a specific digital controlling signal is inputted when an optical disk drive is tested after completion of manufacturing. Then measure a specific driving signal and a specific feedback signal, and further record the specific digital controlling signal, the specific driving signal and the specific feedback signal in the ROM of the optical disk drive. When the decay of the laser diode is determined, the specific digital controlling signal is inputted again, the measured driving signal and the measured feedback signal are compared against the specific driving signal and the specific feedback signal stored in the ROM.

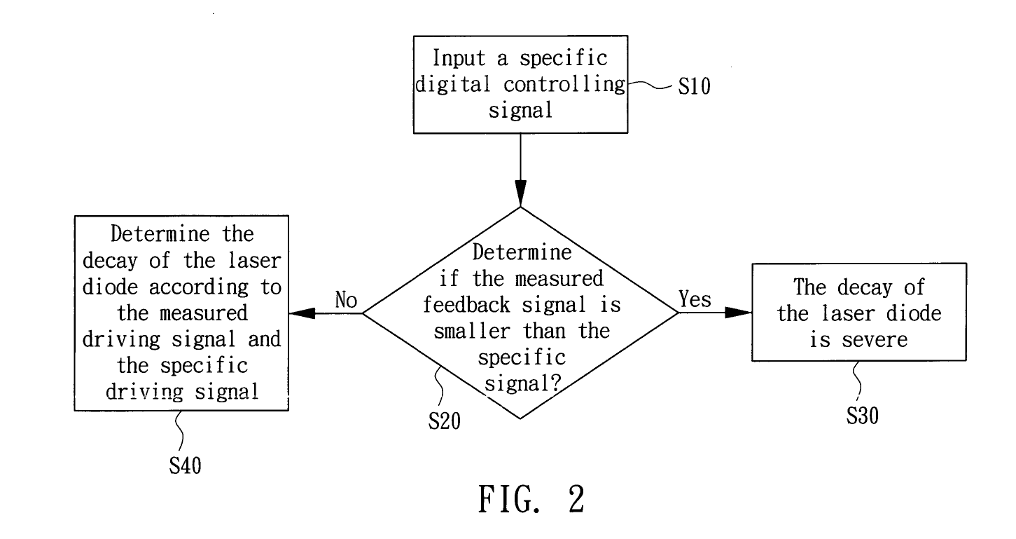

Referring to FIG. 2, a flowchart of determining the decay of a laser diode according to the invention is shown. The specific digital controlling signal, the specific driving signal and the specific feedback signal have already been written into the ROM of the optical disk drive on the completion of the optical disk drive.

Step S10: Input a specific digital controlling signal;

Step S20: Determine if the measured feedback signal is smaller than the specific feedback signal? If yes, go to step S30, otherwise, go to step S40;

Step S30: The decay of the laser diode is severe; and

Step S40: Determine the decay of the laser diode according to the measured driving signal and the specific driving signal.

The compensator is no longer able to compensate the laser power of the laser diode to a level determined by the digital controlling signal, if the measured feedback signal is smaller than the specific feedback signal. This implies that the decay of the laser diode has reached a severe level. However, the decay of the laser diode can be determined according to the difference value of the driving signal and the specific driving signal, if the measured feedback is not smaller than the specific feedback signal. Generally speaking, the larger the difference value is, the severer the decay is.

Moreover, all the specific digital controlling signal, the specific driving signal and the specific feedback signal recorded in the ROM are represented in a digital form, so the invention achieves this digital representation by converting these driving signals and feedback signals into digital ones by an analog-to-digital converter.

So the advantage of the method of determining the decay of a laser diode in the invention is that according to a driving signal and a feedback signal of a closed-loop laser power controlling circuit of the laser diode disposed within an optical disk drive, the decay of the laser diode can be determined efficiently.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of determining the decay of a laser diode applied in a closed-loop controlling circuit, for controlling output power of the laser diode, comprising steps of:
providing a specific digital controlling signal to the closed-loop controlling circuit to enable the laser diode to generate a laser beam;
measuring a measured feedback signal that a front monitor diode of the closed-loop controlling circuit outputs after receiving the laser beam;
measuring a measured driving signal outputted by a compensator of the closed-loop controlling circuit; and
determining the decay of the laser diode according to a specific feedback signal and a specific driving signal as well as the measured feedback signal and the measured driving signal;
wherein the specific digital controlling signal, the specific feedback signal and the specific driving signal are stored in a ROM in advance

2. The method of determining the decay of a laser diode according to claim 1, wherein the laser diode has already severely decayed if the measured feedback signal is smaller than the specific feedback signal.

3. The method of determining the decay of a laser diode according to claim 2, wherein the measured feedback signal, after having been converted by an analog-to-digital circuit, is compared against the specific feedback signal.

4. The method of determining the decay of a laser diode according to claim 1, wherein the decay of the laser diode is determined according to a difference value of the measured driving signal and the specific driving signal if the measured feedback signal is not smaller than the specific feedback signal.

5. The method of determining the decay of a laser diode according to claim 4, wherein the measured feedback signal, after having been converted by an analog-to-digital converter, is compared against the specific feedback signal.

6. The method of determining the decay of a laser diode according to claim 4, wherein the measured driving signal, after having been converted by an analog-to-digital converter, is compared against the specific driving signal.

7. The method of determining the decay of a laser diode according to claim 1, wherein the closed-loop controlling circuit comprises:
a digital-to-analog converter, which generates an analog controlling signal after receiving the specific digital controlling signal;
a compensator, which generates a measured driving signal after receiving a difference value of the analog controlling signal and the measured feedback signal;
an amplifier, which receives the measured driving signal and outputs a driving current;
the laser diode, which receives the driving current and outputs the laser beam; and
the front monitor diode, which generates the measured feedback signal after receiving the laser beam.

8. A method of determining the decay of a laser diode applied in a closed-loop controlling circuit, for controlling output power of the laser diode, comprising steps of:
providing a specific digital controlling signal to the closed-loop controlling circuit to enable the laser diode to generate a laser beam;
measuring a measured feedback signal that a front monitor diode of the closed-loop controlling circuit outputs after receiving the laser beam; and
determining the decay of the laser diode being severe if the measured feedback signal is smaller than a specific feedback signal;
wherein the specific digital controlling signal and the specific feedback signal are stored in a ROM in advance.

9. The method of determining the decay of a laser diode according to claim 8, wherein the measured feedback signal, after having been converted by an analog-to-digital circuit, is compared against the specific feedback signal.

10. The method of determining the decay of a laser diode according to claim 8, wherein the closed-loop controlling circuit comprises:
a digital-to-analog converter, which generates an analog controlling signal after receiving the specific digital controlling signal;
a compensator, which generates a measured driving signal after receiving a difference value of the analog controlling signal and the measured feedback signal;
an amplifier, which receives the measured driving signal and outputs a driving current;
the laser diode, which receives the driving current and outputs the laser beam; and
the front monitor diode, which generates the measured feedback signal after receiving the laser beam.
